(19) United States
(12) Patent Application Publication
(10) Pub. No.: US 2012/0183790 A1
(43) Pub. Date: Jul. 19, 2012

(54) THERMAL SPRAY COMPOSITE COATINGS FOR SEMICONDUCTOR APPLICATIONS

(76) Inventors: Christopher Petorak, Carmel, IN (US); Graeme Dickinson, Scottsdale, AZ (US); Neill Jean McDill, Scottsdale, AZ (US)

(21) Appl. No.: 13/180,748

(22) Filed: Jul. 12, 2011

Related U.S. Application Data
(60) Provisional application No. 61/364,230, filed on Jul. 14, 2010.

(51) Int. Cl. B32B 18/00; B32B 15/04; C23C 4/12; C04B 35/48; C04B 35/04; C04B 35/10; B32B 5/00; C04B 35/01

(52) U.S. Cl. 428/450; 428/469; 428/701; 428/472; 428/471; 428/446; 501/94; 501/103; 501/104; 501/105; 501/108; 501/119; 501/123; 501/125; 501/127; 427/446

(57) ABSTRACT

This invention relates to thermal spray composite coatings on a metal or non-metal substrate. The thermal spray composite coatings comprise a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. This invention also relates to methods of protecting metal and non-metal substrates by applying the thermal spray coatings. The composite coatings provide erosion and corrosion resistance at processing temperatures higher than conventional processing temperatures used in the semiconductor etch industry, e.g., greater than 100° C. The coatings are useful, for example, in the protection of semiconductor manufacturing equipment, e.g., integrated circuit, light emitting diode, display, and photovoltaic, internal chamber components, and electrostatic chuck manufacture.

### RELATED APPLICATIONS

This application claims priority to U.S. Provisional Application Ser. No. 61/364,230 filed on Jul. 14, 2010, which is incorporated herein by reference in its entirety. This application is related to U.S. patent application Ser. No. (103012-R2-US), filed on an even date herewith, which is incorporated herein by reference in its entirety.

### FIELD OF THE INVENTION

This invention relates to thermal spray composite coatings for use in harsh conditions, e.g., composite coatings that provide erosive and corrosive barrier protection in harsh environments such as plasma treating vessels that are used in semiconductor device manufacture. In particular, it relates to composite coatings useful for extending the service life of plasma treating vessel components under severe conditions, such as those components that are used in semiconductor device manufacture. The composite coatings provide erosion and corrosion resistance at processing temperatures higher than conventional processing temperatures used in the semiconductor etch industry, e.g., greater than 100° C. The invention is useful, for example, in the protection of semiconductor manufacturing equipment, e.g., integrated circuit, light emitting diode, display, and photovoltaic, internal chamber components, and electrostatic chuck manufacture.

### BACKGROUND OF THE INVENTION

Thermal spray coatings can be used for the protection of equipment and components used in erosive and corrosive environments. In a semiconductor wafer manufacturing operation, the interior of a processing chamber is exposed to a variety of erosive and corrosive or reactive environments that can result from corrosive gases or other reactive species, including radicals or byproducts generated from process reactions. For example, a halogen compound such as a chloride, fluoride or bromide is typically used as a treating gas in the manufacture of semiconductors. The halogen compound can be disassociated to atomic chlorine, fluorine or bromine in plasma treating vessels used in semiconductor device manufacture, thereby subjecting the plasma treating vessel to a corrosive environment.

Additionally, in plasma treating vessels used in semiconductor device manufacture, the plasma contributes to the formation of finely divided solid particles and also ion bombardment, both of which can result in erosion damage of the process chamber and component parts.

Also, etch operators are performing more processes that result in substantial undesirable byproducts, e.g., polymeric films, and as such are increasing the severity of the cleaning process required for the process chamber and component parts. When exposed to wet cleaning solutions during cleaning cycles of the process chamber and component parts, byproducts generated from plasma-treating chamber operations, such as chlorides, fluorides and bromides, can react to form corrosive species such as HCl and HF, in addition to the corrosive species that may be present in the cleaning cycle, e.g., HCl, HF and HNO₃. The cleaning solutions themselves can be corrosive.

Erosion and corrosion resistant measures are needed to ensure process performance and durability of the process chamber and component parts. There is a need in the art to provide improved erosion and corrosion resistant coatings and to reduce the level of corrosive attack by process reagents. Particularly, there is a need in the art to improve coating properties to provide corrosion and erosion resistance of thermally sprayed coated equipment and components in plasma treating vessels used in semiconductor device manufacture.

Because higher processing temperatures for etch tools leads to higher etch rates (both metal and dielectric etch) which leads to higher wafer throughput for etch processes, erosion and corrosion resistant measures are needed at processing temperatures that are higher than conventional processing temperatures used in the semiconductor etch industry, e.g., greater than 100° C.

### SUMMARY OF THE INVENTION

This invention relates in part to a thermal spray composite coating on a metal or non-metal substrate, said thermal spray coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.

This invention also relates in part to a process for producing a thermal spray composite coating on a metal or non-metal substrate, said thermal spray composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating; said process comprising (i) feeding at least two ceramic coating materials to at least one thermal spray device, (ii) operating said at least one thermal spray device to deposit the at least two ceramic coating materials on said metal or non-metal substrate to produce the ceramic composite coating, and (iii) varying at least one operating parameter of the at least one thermal spray device during deposition of said at least two ceramic coating materials sufficient to randomly and uniformly disperse and/or spatially orient said at least two ceramic material phases throughout the ceramic composite coating.

This invention further relates in part to an article comprising a metal or non-metal substrate and a thermal spray composite coating on the surface thereof; said thermal spray composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.

This invention yet further relates in part to an article comprising a metal or non-metal substrate and a thermal spray composite coating on the surface thereof; said thermal spray composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating; said article prepared by a process comprising (i) feeding at least two ceramic coating materials to at least one thermal spray device, (ii) operating said at least one thermal spray device to deposit the at least two ceramic coating materials on said metal or non-metal substrate to produce the ceramic composite coating, and (iii) varying at least one operating parameter of the at least one thermal spray device during deposition of said at least two ceramic coating materials sufficient to randomly and uniformly disperse and/or spatially orient said at least two ceramic material phases throughout the ceramic composite coating.

This invention also relates in part to a method for protecting a metal or non-metal substrate, said method comprising applying a thermally sprayed composite coating to said metal or non-metal substrate, said thermally sprayed composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.

This invention further relates in part to an internal member for a plasma treating vessel comprising a metallic or ceramic substrate and a thermal spray composite coating on the surface thereof; said thermally sprayed coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.

This invention yet further relates in part to a method for producing an internal member for a plasma treating vessel, said method comprising applying a thermally sprayed composite coating to said internal member, said thermally sprayed composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.

This invention provides improved erosion and corrosion resistant composite coatings, particularly those of the ceramic oxides, e.g., zirconia, yttria, alumina, and alloys and mixtures thereof, to reduce the level of erosive and corrosive attack by process reagents. Particularly, this invention provides corrosion and erosion resistance to thermally sprayed coated equipment and components in plasma treating vessels used in semiconductor device manufacture, e.g., metal and dielectric etch processes. The coatings of this invention provide erosion and corrosion resistance at processing temperatures higher than conventional processing temperatures used in the semiconductor etch industry, e.g., greater than 100° C. The composite coatings also exhibit low particle generation, low metals contamination, and desirable thermal, electrical and adhesion characteristics. The composite coatings of this invention can also provide improved mechanical, electrical and thermal properties in addition to improved plasma erosion and chemical corrosion performance. For example, the composite coatings of this invention may tailor the coefficient of thermal expansion, thermal conductivity and/or electrical resistivity of the composite coatings through selection of materials and phases incorporated in the composite coatings that result in improved composite coatings and/or overall chamber component performance.

### BRIEF DESCRIPTION OF THE DRAWINGS

FIG. 1 is an optical micrograph of a composite coating cross-section. The composite coating is a random and uniform distribution of 70 volume % Y₂O₃ and 30 volume % 17 weight % YSZ.

FIG. 2 is an optical micrograph of a composite coating cross-section. The composite coating is a random and uniform distribution of 30 volume % Y₂O₃ and 70 volume % 17 weight % YSZ.

FIG. 3 is an optical micrograph of a composite coating cross-section. The composite coating is a random and uniform distribution of 50 volume % Y₂O₃ and 50 volume % 17 weight % YSZ.

FIG. 4 is an optical micrograph of a composite coating cross-section. The composite coating is comprised of a topcoat layer and an undercoat layer.

FIG. 5 is a scanning electron microscope (SEM) micrograph of a composite coating cross-section. The composite coating is a random and uniform distribution of 50 volume % Y₂O₃ and 50 volume % 17 weight % YSZ.

FIG. 6 is a SEM micrograph of a composite coating cross-section. The composite coating is comprised of a topcoat layer and an undercoat layer.

FIG. 7 is a SEM micrograph of a composite coating cross-section. The composite coating is comprised of a topcoat layer and an undercoat layer.

FIG. 8 is a SEM micrograph of a composite coating cross-section. The composite coating is comprised of a topcoat layer and an undercoat layer.

FIG. 9 graphically depicts plasma erosion resistance of composite coatings versus single phase coatings made of Y₂O₃ and 17 weight % YSZ.

FIG. 10 graphically depicts plasma erosion resistance of composite coatings versus single phase coatings made of Y₂O₃ and 17 weight % YSZ.

FIG. 11 graphically depicts oxide solubility in 5 weight % HCl after 24 hours for a Y₂O₃ and 17 weight % YSZ powder.

FIG. 12 graphically depicts tensile bond strength results for a baseline yttria coating, and two composite coatings subjected to cyclic corrosion testing with HF. The error bars represent the standard deviation for the sample set.

### DETAILED DESCRIPTION OF THE INVENTION

This invention can minimize damage due to chemical corrosion through a halogen gas and also damage due to plasma erosion. When an internal member component is used in an environment containing the halogen excited by the plasma, it is important to prevent plasma erosion damage caused by ion bombardment, which is then effective to prevent the chemical corrosion caused by halogen species. Byproducts generated from the process reactions include halogen compounds such as chlorides, fluorides and bromides. When exposed to atmosphere or wet cleaning solutions during the cleaning cycles, the byproducts can react to form corrosive species such as HCl and HF, in addition to the corrosive species that may be present in the cleaning cycle, e.g., HCl, HF and HNO₃. The cleaning solutions themselves can be corrosive. The coatings of this invention provide erosion and corrosion resistance at processing temperatures higher than conventional processing temperatures used in the semiconductor etch industry, e.g., greater than 100° C.

This invention provides a solution to the damage incurred by internal members of the plasma-treating vessels. This invention can minimize damage resulting from aggressive cleaning procedures, e.g., CF₄/O₂, CF₄/O₂, SF₆/O₂, BCl₃, and HBr based plasma dry cleaning procedures, used on the internal member components. Because etch operators are performing more processes that result in substantial undesirable byproducts, e.g., polymeric films, increasing the severity of the cleaning process is required to provide process chamber and component parts suitable for semiconductor applications. For example, when exposed to wet cleaning solutions during cleaning cycles of the process chamber and component parts, byproducts generated from plasma-treating chamber operations, such as chlorides, fluorides and bromides, can react to form corrosive species such as HCl and HF, in addition to the corrosive species that may be present in the cleaning cycle, e.g., HCl, HF and HNO₃. This invention can minimize damage due to corrosion resulting from the severe cleaning process. The coated internal member components of this invention can withstand these more aggressive cleaning procedures.

The ceramic materials useful in the thermal spray composite coatings of this invention include, for example, yttrium oxide (yttria), zirconium oxide (zirconia), magnesium oxide (magnesia), cerium oxide (ceria), hafnium oxide (hafnia), aluminum oxide, oxides of Groups 2A to 8B inclusive of the Periodic Table and the Lanthanide elements, or alloys or mixtures or composites thereof. Preferably, the coating materials include yttrium oxide, zirconium oxide, aluminum oxide, cerium oxide, hafnium oxide, gadolinium oxide (gadolinia), ytterbium oxide (ytterbia), or alloys or mixtures or composites thereof. Most preferably, the coating materials include yttria and a zirconia material selected from zirconia, partially stabilized zirconia and fully stabilized zirconia.

The first ceramic material phase can comprise, for example, zirconium oxide, yttrium oxide, magnesium oxide, cerium oxide, aluminum oxide, hafnium oxide, oxides of Groups 2A to 8B inclusive of the Periodic Table and the Lanthanide elements, or alloys or mixtures or composites thereof. Preferably, the first ceramic material phase comprises zirconium oxide, aluminum oxide, yttrium oxide, cerium oxide, hafnium oxide, gadolinium oxide, ytterbium oxide, or alloys or mixtures or composites thereof More preferably, the first ceramic material phase comprises a zirconia-based coating selected from zirconia, partially stabilized zirconia and fully stabilized zirconia, e.g., yttria or ytterbia stabilized zirconia. The first ceramic material phase preferably comprises from about 10 to about 31 weight percent yttria and the balance zirconia, more preferably from about 15 to about 20 weight percent yttria and the balance zirconia. The first ceramic material phase preferably comprises a zirconia-based material having a density from about 60% to about 95% of the theoretical density.

The second ceramic material phase can comprise, for example, yttrium oxide, zirconium oxide, magnesium oxide, cerium oxide, aluminum oxide, hafnium oxide, oxides of Groups 2A to 8B inclusive of the Periodic Table and the Lanthanide elements, or alloys or mixtures or composites thereof Preferably, the second ceramic material phase comprises yttrium oxide, zirconium oxide, aluminum oxide, cerium oxide, hafnium oxide, gadolinium oxide, ytterbium oxide, or alloys or mixtures or composites thereof. More preferably, the second ceramic material phase comprises yttrium oxide.

With the above materials, the surfaces of thermally sprayed composite coatings applied to a plasma treatment vessel or an internal member component used in such a vessel are much more resistant to degradation than bare aluminum, anodized aluminum or sintered aluminum oxide by corrosive gases in combination with radio frequency electric fields which generate gas plasma. Other illustrative coating materials include silicon carbide or boron carbide. With these materials, the surfaces in contact with the etching plasma are those of thermally sprayed composite coatings applied to a plasma etch chamber or component used in the plasma etch processing of silicon wafers for the manufacture of integrated circuits.

The average particle size of the ceramic materials, e.g., powders (particles), useful in this invention is preferably set according to the type of thermal spray device and thermal spraying conditions used during thermal spraying. The ceramic powder particle size (diameter) can range from about 1 to about 150 microns, preferably from about 1 to about 100 microns, more preferably from about 5 to about 75 microns, and most preferably from about 5 to about 50 microns. The average particle size of the powders used to make the ceramic powders useful in this invention is preferably set according to the type of ceramic powder desired. Typically, individual particles useful in preparing the ceramic powders useful in this invention range in size from nano size to about 5 microns in size. Submicron particles are preferred for preparing the ceramic powders useful in this invention.

The thermal spraying powders useful in this invention can be produced by conventional methods such as agglomeration (spray dry and sinter or sinter and crush methods) or cast and crush. In a spray dry and sinter method, a slurry is first prepared by mixing a plurality of raw material powders and a suitable dispersion medium. This slurry is then granulated by spray drying, and a coherent powder particle is then formed by sintering the granulated powder. The thermal spraying powder is then obtained by sieving and classifying (if agglomerates are too large, they can be reduced in size by crushing). The sintering temperature during sintering of the granulated powder is preferably 800 to 1600° C. Plasma densification of spray dried and sintered particles and also cast and crush particles can be conducted by conventional methods. Also, atomization of ceramic oxide melts can be conducted by conventional methods.

The thermal spraying powders useful in this invention may be produced by another agglomeration technique, sinter and crush method. In the sinter and crush method, a compact is first formed by mixing a plurality of raw material powders followed by compression and then sintered at a temperature between 1200 to 1400° C. The thermal spraying powder is then obtained by crushing and classifying the resulting sintered compact into the appropriate particle size distribution.

The thermal spraying powders useful in this invention may also be produced by a cast (melt) and crush method instead of agglomeration. In the melt and crush method, an ingot is first formed by mixing a plurality of raw material powders followed by rapid heating, casting and then cooling. The thermal spraying powder is then obtained by crushing and classifying the resulting ingot.

The thermally sprayed composite coatings useful in this invention can be made from a ceramic powder comprising ceramic powder particles, wherein the average particle size of the ceramic powder particles can range from about 1 to about 150 microns.

As used herein, a “composite” is a multiphase, artificially made, material that forms distinct interfaces between material phases and is comprised of more than one chemically distinct material phases. Material properties of the composite are enhanced or detracted by the combination of the two or more distinct material phases. The composite materials can be used to tailor specific material properties unattainable through a single phase material. The composite properties are not only a product of the material phases, but also of the processing method. Material properties of the composite are a function of volume concentration of constituent phases, size and shape of the constituent phases, and distribution and spatial orientation of the constituent phases relative to one another. In accordance with this invention, enhancements of composite properties include, for example, corrosion resistance and plasma erosion resistance, and may also include changes in mechanical, thermal or electrical properties.

This invention relates to a thermal spray composite coating on a metal or non-metal substrate. The thermal spray composite coating comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The ceramic material phases have interfaces therebetween. A preferred ceramic composite coating includes randomly and uniformly dispersed and/or spatially oriented phases of yttria and a zirconia material selected from zirconia, partially stabilized zirconia and fully stabilized zirconia. A preferred zirconia material is yttria stabilized zirconia.

The first ceramic material phase has a size and shape sufficient to provide corrosion resistance to the ceramic composite coating. The second ceramic material phase has a size and shape sufficient to provide plasma erosion resistance to the ceramic composite coating.

The first ceramic material phase is, relative to the second ceramic material phase, randomly and uniformly dispersed throughout the ceramic composite coating and/or spatially oriented throughout the ceramic composite coating sufficient to provide corrosion resistance to the ceramic composite coating. The second ceramic material phase is, relative to the first ceramic material phase, randomly and uniformly dispersed throughout the ceramic composite coating and/or spatially oriented throughout the ceramic composite coating sufficient to provide plasma erosion resistance to the ceramic composite coating.

The ceramic composite coatings of this invention can be prepared by a process that comprises (i) feeding at least two ceramic coating materials to at least one thermal spray device, (ii) operating the at least one thermal spray device to deposit the at least two ceramic coating materials on a metal or non-metal substrate to produce the ceramic composite coating, and (iii) varying at least one operating parameter of the at least one thermal spray device during deposition of the at least two ceramic coating materials sufficient to randomly and uniformly disperse and/or spatially orient the at least two ceramic material phases throughout the ceramic composite coating.

Referring to the process, the operating parameters of the at least one thermal spray device that can be varied include temperature of the depositing the at least two ceramic coating materials, velocity of the depositing at least two ceramic coating materials as they contact the metal or non-metal substrate, and standoff of the at least one thermal spray device.

The at least two ceramic coating materials can be heated to about their melting point to form droplets of the at least two ceramic coating materials, and the droplets are accelerated in a gas flow stream to contact the metal or non-metal substrate.

The temperature parameters of the at least two ceramic coating materials include temperature and enthalpy of the gas flow stream; composition and thermal properties of the droplets; size and shape distributions of the droplets; mass flow rate of the droplets relative to the gas flow rate; and time of transit of the droplets to the metal or non-metal substrate.

The velocity parameters of the at least two ceramic coating materials include gas flow rate; size and shape distribution of the droplets; and mass injection rate and density of the droplets.

The first ceramic material phase is present in the ceramic composite coatings of this invention in an amount of from about 1 volume % to about 99 volume %, preferably form about 30 volume % to about 70 volume %, and more preferably from about 40 volume % to about 60 volume %. The second ceramic material phase is present in the ceramic composite coatings of this invention in an amount of from about 1 volume % to about 99 volume %, preferably form about 30 volume % to about 70 volume %, and more preferably from about 40 volume % to about 60 volume %.

The thickness of these composite coatings can range from about 0.001 to about 0.1 inches, preferably from about 0.005 to about 0.05 inches, more preferably from about 0.005 to about 0.01 inches.

These ceramic composite coatings have at least two ceramic material phases randomly and uniformly dispersed and/or spatially oriented throughout the ceramic composite coating. As used herein, “randomly and uniformly dispersed” means that the ceramic material phases are homogeneously or heterogeneously distributed throughout the volume of the coating. As used herein, “spatially oriented” means that the ceramic material phases are heterogeneously distributed throughout the volume of the coating.

A randomly oriented composite material having a heterogeneous distribution of ceramic material phases with isotropic material properties shows no preference to phase as a function of position or orientation in the volume of the bulk composite. In contrast, a spatially oriented composite material having a heterogeneous distribution of material phases with anisotropic material properties provides a distinct correlation between position or orientation and the material phase at that position or with set orientation. Such spatially oriented thermally sprayed microstructures may include, for example, the structural variety where the bulk composite is made up of many intermittent stacked sublayers for each distinct phase. The bulk composite shows a dependency upon direction. Properties out-of-plane will vary from in-plane properties.

Layering and sublayering produces coatings with distinct locations of one material within the coating volume with respect to other materials within the coating volume. Ceramic material phases can be “randomly and uniformly dispersed” and/or “spatially oriented” in the composite coatings of this invention and can be utilized to achieve either isotropic or anisotropic material properties.

The ceramic composite coatings can have a porosity at or near the interface of the ceramic composite coating and the metal or non-metal substrate sufficient to provide a compliant ceramic composite coating capable of straining under thermal expansion mismatch between the ceramic composite coating and the metal or non-metal substrate at elevated temperature. The ceramic composite coating is a compliant material capable of withstanding stresses due to the thermal expansion mismatch between the metal or non-metal substrate and the ceramic composite coating. This mismatch in thermal expansion between the ceramic composite coating and the metal or non-metal substrate can lead to crack propagation at the ceramic composite coating/substrate interface. An important function of the ceramic composite coating is to mitigate interfacial stresses at the ceramic composite coating/substrate interface, so that the ceramic composite coating can accommodate thermal expansion of a substrate at high temperature without catastrophic cracking and spallation. The undercoat, topcoat and/or sublayers can contain equivalent and/or different levels of porosity dependent upon the properties desired for each layer. In addition, the porosity in each layer can be graded or continuous throughout the layer.

This invention also relates to a thermal spray composite coating for a metal or non-metal substrate that includes (i) a thermal spray undercoat layer applied to the metal or non-metal substrate, and (ii) a thermal spray topcoat layer applied to the undercoat layer. The thermal spray undercoat layer comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The thermal spray topcoat layer comprises a ceramic coating having a thickness sufficient to provide corrosion resistance and/or plasma erosion resistance to the thermal spray composite coating.

The thermal spray composite coatings of this invention can further comprise at least one thermal spray intermediate layer between said thermal spray undercoat layer and said thermal spray topcoat layer. The thermal spray intermediate layer can comprise a ceramic composite coating having at least two ceramic material phases randomly and uniformly dispersed throughout the ceramic composite coating and/or spatially oriented throughout the ceramic composite coating. The at least a first ceramic material phase can be present in an amount sufficient to provide corrosion resistance to the ceramic composite coating. The at least a second ceramic material phase can be present in an amount sufficient to provide plasma erosion resistance to the ceramic composite coating. The thermal spray intermediate layer can be different from the thermal spray undercoat layer.

The first ceramic material phase has a size and shape sufficient to provide corrosion resistance to said ceramic composite coating. The second ceramic material phase has a size and shape sufficient to provide plasma erosion resistance to said ceramic composite coating.

The first ceramic material phase is, relative to the second ceramic material phase, randomly and uniformly dispersed throughout said ceramic composite coating and/or spatially oriented throughout said ceramic composite coating sufficient to provide corrosion resistance to the ceramic composite coating. The second ceramic material phase is, relative to the first ceramic material phase, randomly and uniformly dispersed throughout said ceramic composite coating and/or spatially oriented throughout said ceramic composite coating sufficient to provide plasma erosion resistance to the ceramic composite coating.

The ceramic composite coatings of this invention can be prepared by a process that comprises (i) feeding at least two ceramic coating materials to at least one thermal spray device, (ii) operating said at least one thermal spray device to deposit the undercoat layer on said metal or non-metal substrate, (iii) varying at least one operating parameter of the at least one thermal spray device during deposition of said at least two ceramic coating materials sufficient to randomly and uniformly disperse and/or spatially orient said at least two ceramic material phases throughout the undercoat layer, (iv) feeding at least one ceramic coating material to said at least one thermal spray device, (v) operating said at least one thermal spray device to deposit the topcoat layer on the undercoat layer to produce the thermal spray composite coating.

Referring to the process, the operating parameters of the at least one thermal spray device that can be varied include temperature of the depositing the at least two ceramic coating materials, velocity of the depositing at least two ceramic coating materials as they contact the metal or non-metal substrate, and standoff of the at least one thermal spray device.

The at least two ceramic coating materials can be heated to about their melting point to form droplets of the at least two ceramic coating materials, and the droplets are accelerated in a gas flow stream to contact said metal or non-metal substrate.

The temperature parameters of the at least two ceramic coating materials include temperature and enthalpy of the gas flow stream; composition and thermal properties of the droplets; size and shape distributions of the droplets; mass flow rate of the droplets relative to the gas flow rate; and time of transit of the droplets to the metal or non-metal substrate.

The velocity parameters of the at least two ceramic coating materials include gas flow rate; size and shape distribution of the droplets; and mass injection rate and density of the droplets.

The first ceramic material phase is present in the ceramic composite coatings of this invention in an amount of from about 1 volume % to about 99 volume %, preferably form about 30 volume % to about 70 volume %, and more preferably from about 40 volume % to about 60 volume %. The second ceramic material phase is present in the ceramic composite coatings of this invention in an amount of from about 1 volume % to about 99 volume %, preferably form about 30 volume % to about 70 volume %, and more preferably from about 40 volume % to about 60 volume %.

The ceramic composite coatings of this invention can comprise one or more layers. The thermal spray undercoat layer can comprise one or more sublayers. Likewise, the thermal spray topcoat layer can comprise one or more sublayers.

With regard to these thermal spray composite coatings having an undercoat layer and a topcoat layer, the thickness of these coatings can range from about 0.001 to about 0.1 inches, preferably from about 0.005 to about 0.05 inches, more preferably from about 0.005 to about 0.01 inches. The thickness of the undercoat layer can range from about 0.0005 to about 0.1 inches, preferably from about 0.001 to about 0.01 inches, and more preferably from about 0.002 to about 0.005 inches. The thickness of the topcoat layer can range from about 0.0005 to about 0.1 inches, preferably from about 0.001 to about 0.01 inches, and more preferably from about 0.002 to about 0.005 inches.

These ceramic composite coatings have at least two ceramic material phases randomly and uniformly dispersed and/or spatially oriented throughout the ceramic composite coating. As used herein, “randomly and uniformly dispersed” means that the ceramic material phases are homogeneously or heterogeneously distributed throughout the volume of the coating. As used herein, “spatially oriented” means that the ceramic material phases are heterogeneously distributed throughout the volume of the coating.

A randomly oriented composite material having a heterogeneous distribution of ceramic material phases with isotropic material properties shows no preference to phase as a function of position or orientation in the volume of the bulk composite. In contrast, a spatially oriented composite material having a heterogeneous distribution of material phases with anisotropic material properties provides a distinct correlation between position or orientation and the material phase at that position or with set orientation. Such spatially oriented thermally sprayed microstructures may include, for example, the structural variety where the bulk composite is made up of many intermittent stacked sublayers for each distinct phase. The bulk composite shows a dependency upon direction. Properties out-of-plane will vary from in-plane properties.

Layering and sublayering produces coatings with distinct locations of one material within the coating volume with respect to other materials within the coating volume. Ceramic material phases can be “randomly and uniformly dispersed” and/or “spatially oriented” in the composite coatings of this invention and can be utilized to achieve either isotropic or anisotropic material properties.

The undercoat layer can have a porosity at or near the interface of the undercoat layer and the metal or non-metal substrate sufficient to provide a compliant ceramic coating capable of straining under thermal expansion mismatch between the ceramic coating and the metal or non-metal substrate at elevated temperature. The undercoat layer is a compliant material capable of withstanding stresses due to the thermal expansion mismatch between the metal or non-metal substrate and the undercoat layer. This mismatch in thermal expansion between the undercoat layer and the metal or non-metal substrate can lead to crack propagation at the undercoat layer/substrate interface. An important function of the undercoat layer is to mitigate interfacial stresses at the undercoat layer/substrate interface, so that the undercoat layer can accommodate thermal expansion of a substrate at high temperature without catastrophic cracking and spallation.

Erosion and corrosion resistant properties of the thermal spray composite coatings of this invention can be further improved by blocking or sealing the inter-connected residual micro-porosity inherent in thermally sprayed composite coatings. Sealers can include hydrocarbon, siloxane, or polyimid based materials with out-gassing properties of less than about 1% TML (total mass loss) and less than about 0.05 CVCM (collected condensable volatile materials), preferably less than about 0.5% TML, less than about 0.02% CVCM. Sealants can also be advantageous in semiconductor device manufacture as sealed coatings on internal chamber components and electrostatics chucks will reduce chamber conditioning time when compared to as-coated or sintered articles. Conventional sealants can be used in the methods of this invention. The sealants can be applied by conventional methods known in the art.

This invention relates to a process for producing a thermal spray composite coating on a metal or non-metal substrate. The thermal spray composite coating comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The process comprises (i) feeding at least two ceramic coating materials to at least one thermal spray device, (ii) operating the at least one thermal spray device to deposit the at least two ceramic coating materials on the metal or non-metal substrate to produce the ceramic composite coating, and (iii) varying at least one operating parameter of the at least one thermal spray device during deposition of the at least two ceramic coating materials sufficient to randomly and uniformly disperse and/or spatially orient the at least two ceramic material phases throughout the ceramic composite coating.

This invention also relates to a process for producing a thermal spray composite coating on a metal or non-metal substrate. The thermal spray composite coating comprises (i) a thermal spray undercoat layer applied to the metal or non-metal substrate, and (ii) a thermal spray topcoat layer applied to the undercoat layer. The thermal spray undercoat layer comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The thermal spray topcoat layer comprises a ceramic coating having a thickness sufficient to provide corrosion resistance and/or plasma erosion resistance to the thermal spray composite coating. The process comprises (a) feeding at least two ceramic coating materials to at least one thermal spray device, (b) operating the at least one thermal spray device to deposit the undercoat layer on the metal or non-metal substrate, (c) varying at least one operating parameter of the at least one thermal spray device during deposition of the at least two ceramic coating materials sufficient to randomly and uniformly disperse and/or spatially orient the at least two ceramic material phases throughout the undercoat layer, (d) feeding at least one ceramic coating material to the at least one thermal spray device, (e) operating the at least one thermal spray device to deposit the topcoat layer on the undercoat layer to produce the thermal spray composite coating.

Referring to the processes above, the operating parameters of the at least one thermal spray device that can be varied include temperature of the depositing the at least two ceramic coating materials, velocity of the depositing at least two ceramic coating materials as they contact the metal or non-metal substrate, and standoff of the at least one thermal spray device.

The at least two ceramic coating materials can be heated to about their melting point to form droplets of the at least two ceramic coating materials, and the droplets are accelerated in a gas flow stream to contact the metal or non-metal substrate.

The temperature parameters of the at least two ceramic coating materials include temperature and enthalpy of the gas flow stream; composition and thermal properties of the droplets; size and shape distributions of the droplets; mass flow rate of the droplets relative to the gas flow rate; and time of transit of the droplets to the metal or non-metal substrate.

The velocity parameters of the at least two ceramic coating materials include gas flow rate; size and shape distribution of the droplets; and mass injection rate and density of the droplets.

This invention relates to an article that comprises a metal or non-metal substrate and a thermal spray composite coating on the surface thereof. The thermal spray composite coating comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating.

This invention also relates to an article that comprises a metal or non-metal substrate and a thermal spray composite coating on the surface thereof. The thermal spray composite coating comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The article is prepared by a process that comprises (i) feeding at least two ceramic coating materials to at least one thermal spray device, (ii) operating the at least one thermal spray device to deposit the at least two ceramic coating materials on the metal or non-metal substrate to produce the ceramic composite coating, and (iii) varying at least one operating parameter of the at least one thermal spray device during deposition of the at least two ceramic coating materials sufficient to randomly and uniformly disperse and/or spatially orient the at least two ceramic material phases throughout the ceramic composite coating.

This invention relates to an article that comprises a metal or non-metal substrate and a thermal spray composite coating on the surface thereof. The thermal spray composite coating comprises (i) a thermal spray undercoat layer applied to the metal or non-metal substrate, and (ii) a thermal spray topcoat layer applied to the undercoat layer. The thermal spray undercoat layer comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The thermal spray topcoat layer comprises a ceramic coating having a thickness sufficient to provide corrosion resistance and/or plasma erosion resistance to the thermal spray composite coating.

This invention also relates to an article that comprises a metal or non-metal substrate and a thermal spray composite coating on the surface thereof. The thermal spray composite coating comprises (i) a thermal spray undercoat layer applied to the metal or non-metal substrate, and (ii) a thermal spray topcoat layer applied to the undercoat layer. The thermal spray undercoat layer comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The thermal spray topcoat layer comprises a ceramic coating having a thickness sufficient to provide corrosion resistance and/or plasma erosion resistance to the thermal spray composite coating. The article is prepared by a process that comprises (a) feeding at least two ceramic coating materials to at least one thermal spray device, (b) operating the at least thermal spray device to deposit the undercoat layer on the metal or non-metal substrate, (c) varying at least one operating parameter of the at least one thermal spray device during deposition of the at least two ceramic coating materials sufficient to randomly and uniformly disperse and/or spatially orient the at least two ceramic material phases throughout the undercoat layer, (d) feeding at least one ceramic coating material to the at least one thermal spray device, (e) operating the at least one thermal spray device to deposit the topcoat layer on the undercoat layer to produce the thermal spray composite coating.

Composite coatings may be produced using the ceramic powders described above by a variety of methods well known in the art. These methods include thermal spray (plasma, HVOF, detonation gun, etc.), electron beam physical vapor deposition (EBPVD), laser cladding; and plasma transferred arc. Thermal spray is a preferred method for deposition of the ceramic powders to form the erosive and corrosive resistant composite coatings of this invention. The erosion and corrosion resistant composite coatings of this invention are formed from ceramic powders having the same composition.

The ceramic composite coating can be deposited onto a metal or non-metal substrate using any thermal spray device by conventional methods. Preferred thermal spray methods for depositing the ceramic composite coatings are plasma spraying including inert gas shrouded plasma spraying and low pressure or vacuum plasma spraying in chambers. Other deposition methods that may be useful in this invention include high velocity oxygen-fuel torch spraying, detonation gun coating and the like. The most preferred method is inert gas shrouded plasma spraying and low pressure or vacuum plasma spraying in chambers. It could also be advantageous to heat treat the ceramic composite coating using appropriate times and temperatures to achieve a good bond for the ceramic composite coating to the substrate and a high sintered density of the ceramic composite coating. Other means of applying a uniform deposit of powder to a substrate in addition to thermal spraying include, for example, electrophoresis, electroplating and slurry deposition. The preferred thermal spray devices useful in this invention are selected from a plasma spray device, a high velocity oxygen fuel device, a detonation gun, and an electric wire arc spray device.

The coating materials are typically fed to the thermal spray device in the form of powder, although one or more of the constituents could be fed in the form of wire or rod. When the coating materials are in the form of powder they may be blended mechanically and fed from a single powder dispenser to the thermal spray device or fed from two or more powder dispensers to the thermal spray device. The coating materials may be fed to the thermal spray device internally as in most detonation gun and high velocity oxygen fuel devices or externally as in many plasma spray devices. The changes in deposition parameters including gas composition and flow rates, power levels, surface speed, coating material injection rates, and torch position relative to the substrate may be changed during the deposition process either manually by the equipment operator or automatically by computer control.

In those situations in which the thermal spray device is a detonation gun, the thermal content of the gas stream in the gun, as well as the velocity of the gas stream, can be varied by changing the composition of the gas mixtures. Both the fuel gas composition and the ratio of fuel to oxidant can be varied. The oxidant is usually oxygen. In the case of detonation gun deposition, the fuel is usually acetylene. In the case of Super D-Gun deposition, the fuel is usually a mixture of acetylene and another fuel such as propylene. The thermal content can be reduced by adding a neutral gas such as nitrogen.

In those situations in which the thermal spray device is a high velocity oxygen fuel torch or gun, the thermal content and velocity of the gas stream from the torch or gun can be varied by changing the composition of the fuel and the oxidant. The fuel may be a gas or liquid as described above. The oxidant is usually oxygen gas, but may be air or another oxidant.

The process of this invention preferably employs plasma spray methodology. The plasma spraying is suitably carried out using fine agglomerated powder particle sizes, typically having an average agglomerated particle size of less than about 50 microns, preferably less than about 40 microns, and more preferably from about 5 to about 50 microns. Individual particles useful in preparing the agglomerates typically range in size from nanocrystalline size to about 5 microns in size. The plasma medium can be nitrogen, hydrogen, argon, helium or a combination thereof.

The thermal content of the plasma gas stream can be varied by changing the electrical power level, gas flow rates, or gas composition. Argon is usually the base gas, but helium, hydrogen and nitrogen are frequently added. The velocity of the plasma gas stream can also be varied by changing the same parameters.

Variations in gas stream velocity from the plasma spray device can result in variations in particle velocities and hence dwell time of the particle in flight. This affects the time the particle can be heated and accelerated and, hence, its maximum temperature and velocity. Dwell time is also affected by the distance the particle travels between the torch or gun and the surface to be coated.

The specific deposition parameters depend on both the characteristics of the plasma spray device and the materials being deposited. The rate of change or the length of time the parameters are held constant are a function of both the required composite coating composition, the rate of traverse of the gun or torch relative to the surface being coated, and the size of the part. Thus, a relatively slow rate of change when coating a large part may be the equivalent of a relatively large rate of change when coating a small part.

The invention relates to a thermal spray process for the deposition of composite coatings having at least two distinct ceramic material phases randomly and uniformly dispersed and/or spatially oriented throughout the composite coatings, and to coated articles produced thereby. More particularly, the invention relates to feeding at least two coating materials to at least one thermal spray device, e.g., feeding two ceramic materials each to a separate thermal spray device that are used to create a single homogeneously mixed ceramic composite coating (referred to as co-spraying), and continuously or intermittently changing the composition of the deposited composite coatings by changing the thermal spray operating parameters. The composite coating can retain a single composition throughout the coating volume, or the composition can continuously or intermittently change throughout the coating volume.

The invention relates to a process for producing a thermal spray composite coating on a substrate comprising the feeding of at least two coating materials to at least one thermal spray device and varying at least one of the deposition parameters of the at least one thermal spray device during the deposition operating thereby varying the composition of the deposited coating material to produce a composite coating on the substrate. The composite coating has at least two ceramic material phases randomly and uniformly dispersed and/or spatially oriented throughout the composite coating. The composite coating can retain a single composition throughout the coating volume, or the composition can continuously or intermittently change throughout the coating volume. The at least one thermal spray device useful in the process of this invention has parameters that can control or monitor the temperature of the depositing coating material and the velocity of the coating material particles.

The invention also relates to deposition by the coating process of this invention of unique coating structures with smoothly varying gradations in composition properties. Since the changes in deposition parameters can be made while the composite coating is being continuously deposited, the gradation or changes in composition properties and their reflected changes in material properties can also continuously change during deposition. If the composite coating is being continuously deposited, the gradation or changes in composition properties can be continuous or non-discrete. If the composite coating is being intermittently deposited, the gradation or changes in composition properties can be very discrete.

In addition, the ceramic composite coatings of this invention can be deposited in multiple layers or sublayers. Using the process of this invention, each layer or sublayer may be slightly different than the preceding or succeeding layer or sublayer. The time between layers or sublayers is only dependent on the size of the substrate and the traverse rate (the relative rate of motion between the coating device and the substrate) and the advance rate (the distance a torch advances across a part after a single stroke or RPM (rotation per minute)), since the composite coating is being deposited continuously by the coating device. The difference between layers or sublayers is a function of the rate of change in deposition parameters and the traverse rate. How discrete a gradation is then a function of the thickness of the individual layers or sublayers that can be made very thin or thick.

The ceramic composite coating can comprise one or more layers. The thermal spray undercoat layer can comprise one or more sublayers. Likewise, the thermal spray topcoat layer can comprise one or more sublayers.

A randomly oriented composite material having a heterogeneous distribution of ceramic material phases with isotropic material properties shows no preference to phase as a function of position or orientation in the volume of the bulk composite. In contrast, a spatially oriented composite material having a heterogeneous distribution of material phases with anisotropic material properties provides a distinct correlation between position or orientation and the material phase at that position or with set orientation. Such spatially oriented thermally sprayed microstructures may include, for example, the structural variety where the bulk composite is made up of many intermittent stacked sublayers for each distinct phase. The bulk composite shows a dependency upon direction. Properties out-of-plane will vary from in-plane properties.

Layering and sublayering produces coatings with distinct locations of one material within the coating volume with respect to other materials within the coating volume. Ceramic material phases can be “randomly and uniformly dispersed” and/or “spatially oriented” in the composite coatings of this invention and can be utilized to achieve either isotropic or anisotropic material properties. The total thickness of the composite coating is a function of the requirements of the application. The total thickness of the composite coating is typically in the range of about 0.001 to about 0.1 inches, but may be thicker or thinner if it is necessary to satisfy the specific requirements of the application. This invention also relates to articles with the composite coatings of this invention. Such articles include those requiring coatings with composite properties to enhance the corrosion resistance and plasma erosion resistance of the composite coating.

The composite coatings of this invention can be used to enhance the corrosion resistance and plasma erosion resistance of a coating system, as well as for other purposes. In an embodiment, the layer of coating next to the substrate can be a composite ceramic material, and the outermost coating layer can be a ceramic material. The composite ceramic layer may bond better to the substrate than the ceramic directly to the substrate. It also may improve the mechanical impact resistance and other properties of the total coating by providing a layer of intermediate mechanical properties such as elastic modulus. The thermal shock resistance of a coated system may also be increased with a composite ceramic intermediate layer by increasing the bond strength of the system.

As indicated above, a suitable thickness for the thermally sprayed composite coatings of this invention can range from about 0.001 to about 0.1 inches depending on any allowance for dimensional grinding, the particular application and the thickness of any other layers. For typical applications and erosive and corrosive environments, the composite coating thickness may range from about 0.001 to about 0.05 inches, preferably from about 0.005 to about 0.01 inches, but thicker composite coatings will be needed to accommodate reduction in final thickness by any abrading procedure. In other words, any such abrading procedure will reduce the final thickness of the composite coating.

Illustrative metallic and non-metallic internal member substrates include, for example, aluminum and its alloys, typified by aluminum 6061 in the T6 condition and sintered aluminum oxide. Other illustrative substrates include various steels inclusive of stainless steel, nickel, iron and cobalt based alloys, tungsten and tungsten alloy, titanium and titanium alloy, molybdenum and molybdenum alloy, and certain non-oxide sintered ceramics, and the like.

In an embodiment, an internal aluminum member can be anodized prior to applying the thermal spray composite coating. A few metals can be anodized but aluminum is the most common. Anodization is a reaction product formed in situ by anodic oxidation of the substrate by an electrochemical process. The anodic layer formed by anodization is aluminum oxide which is a ceramic.

Other suitable metal substrates include, for example, nickel base superalloys, nickel base superalloys containing titanium, cobalt base superalloys, and cobalt base superalloys containing titanium. Preferably, the nickel base superalloys would contain more than 50% by weight nickel and the cobalt base superalloys would contain more than 50% by weight cobalt. Illustrative non-metal substrates include, for example, permissible silicon-containing materials.

This invention relates to a method for producing an internal member for a plasma treating vessel. The method comprises applying a thermally sprayed composite coating to the internal member. The thermally sprayed composite coating comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating.

This invention also relates to a method for producing an internal member for a plasma treating vessel. The method comprises applying a thermal spray composite coating to the internal member. The thermal spray composite coating comprises (i) a thermal spray undercoat layer applied to the internal member, and (ii) a thermal spray topcoat layer applied to the undercoat layer. The thermal spray undercoat layer comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The thermal spray topcoat layer comprises a ceramic coating having a thickness sufficient to provide corrosion resistance and/or plasma erosion resistance to the thermal spray composite coating.

The coated internal members of this invention can be prepared by flowing powder through a thermal spraying device that heats and accelerates the powder onto a base (substrate). Upon impact, the heated particle deforms resulting in a thermal sprayed lamella or splat. Overlapping splats make up the composite coating structure. A plasma spray process useful in this invention is disclosed in U.S. Pat. No. 3,016,447, the disclosure of which is incorporated herein by reference. A detonation process useful in this invention is disclosed in U.S. Pat. Nos. 4,519,840 and 4,626,476, the disclosures of which are incorporated herein by reference, which include coatings containing tungsten carbide cobalt chromium compositions. U.S. Pat. No. 6,503,290, the disclosure of which is incorporated herein by reference, discloses a high velocity oxygen fuel process that may be useful in this invention to coat compositions containing W, C, Co, and Cr. Cold spraying methods known in the art may also be useful in this invention. Typically, such cold spraying methods use liquid helium gas which is expanded through a nozzle and allowed to entrain powder particles. The entrained powder particles are then accelerated to impact upon a suitably positioned workpiece.

In coating the internal members of this invention, the thermal spraying powder is thermally sprayed onto the surface of the internal member, and as a result, a thermal sprayed composite coating is formed on the surface of the internal member. High-velocity-oxygen-fuel or detonation gun spraying are illustrative methods of thermally spraying the thermal spraying powder. Other coating formation processes include plasma spraying, plasma transfer arc (PTA), or flame spraying. For electronics applications, plasma spraying is preferred for zirconia, yttria and alumina coatings because there is no hydrocarbon combustion and therefore no source of contamination. Plasma spraying uses clean electrical energy. Preferred composite coatings for thermally spray coated articles of this invention include, for example, yttrium oxide, zirconium oxide, magnesium oxide, cerium oxide, aluminum oxide, hafnium oxide, oxides of Groups 2A to 8B inclusive of the Periodic Table and the Lanthanide elements, or alloys or mixtures or composites thereof.

This invention relates to an internal member for a plasma treating vessel that comprises a metallic or ceramic substrate and a thermal spray composite coating on the surface thereof. The thermally sprayed coating comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating.

This invention also relates to an internal member for a plasma treating vessel that comprises a metallic or ceramic substrate and a thermal spray composite coating on the surface thereof. The thermal spray composite coating comprises (i) a thermal spray undercoat layer applied to the metal or non-metal substrate, and (ii) a thermal spray topcoat layer applied to the undercoat layer. The thermal spray undercoat layer comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The thermal spray topcoat layer comprises a ceramic coating having a thickness sufficient to provide corrosion resistance and/or plasma erosion resistance to the thermal spray composite coating.

Illustrative internal member components for a plasma treating vessel used in the production of an integrated circuit include, for example, a deposit shield, baffle plate, focus ring, insulator ring, shield ring, bellows cover, electrode, chamber liner, cathode liner, gas distribution plate, electrostatic chucks (for example, the sidewalls of electrostatic chucks), and the like. This invention is generally applicable to components subjected to corrosive environments such as internal member components for plasma treating vessels. This invention provides corrosive barrier systems that are suitable for protecting the surfaces of such internal member components. While the advantages of this invention will be described with reference to internal member components, the teachings of this invention are generally applicable to any component on which a corrosive barrier coating may be used to protect the component from a corrosive environment.

According to this invention, internal member components intended for use in corrosive environments of plasma treating vessels are thermal spray coated with a protective coating layer. The thermal sprayed coated internal member component formed by the method of this invention can have desired corrosion resistance, plasma erosion resistance, and wear resistance.

The composite coatings of this invention are useful for chemical processing equipment used at low and high temperatures, e.g., in harsh erosive and corrosive environments. In harsh environments, the equipment can react with the material being processed therein. Ceramic materials that are inert towards the chemicals can be used as coatings on the metallic equipment components. The ceramic composite coatings should be impervious to prevent erosive and corrosive materials from reaching the metallic equipment. A composite coating which can be inert to such erosive and corrosive materials and prevent the erosive and corrosive materials from reaching the underlying substrate will enable the use of less expensive substrates and extend the life of the equipment components.

The thermal sprayed composite coatings of this invention show desirable resistance when used in an environment subject to plasma erosion action in a gas atmosphere containing a halogen gas. For example, even when plasma etching operation is continued over a long time, the contamination through particles in the deposition chamber is less and a high quality internal member component can be efficiently produced. By the practice of this invention, the rate of generation of particles in a plasma process chamber can become slower, so that the interval for the cleaning operation becomes longer increasing productivity. As a result, the coated internal members of this invention can be effective in a plasma treating vessel in a semiconductor production apparatus. Also, internal members coated with a thermal spray composite coating of this invention exhibit good erosion resistance.

This invention relates to a method for protecting a metal or non-metal substrate. The method comprises applying a thermally sprayed composite coating to the metal or non-metal substrate. The thermally sprayed composite coating comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating.

This invention also relates to a method for protecting a metal or non-metal substrate. The method comprises applying a thermal spray composite coating to the metal or non-metal substrate. The thermal spray composite coating comprises (i) a thermal spray undercoat layer applied to the internal member, and (ii) a thermal spray topcoat layer applied to the undercoat layer. The thermal spray undercoat layer comprises a ceramic composite coating having at least two ceramic material phases randomly and uniformly dispersed and/or spatially oriented throughout the ceramic composite coating. At least a first ceramic material phase is present in an amount sufficient to provide corrosion resistance to the ceramic composite coating, and at least a second ceramic material phase is present in an amount sufficient to provide plasma erosion resistance to the ceramic composite coating. The thermal spray topcoat layer comprises a ceramic coating having a thickness sufficient to provide corrosion resistance and/or plasma erosion resistance to the thermal spray composite coating.

The thermal spray composite coatings of this invention, in comparison to the corrosion and/or erosion resistance provided to a substrate by a corresponding ceramic coating, provide about 25 percent or greater corrosion and/or erosion resistance to the substrate, preferably about 40 percent or greater corrosion and/or erosion resistance to the substrate, and more preferably about 50 percent or greater corrosion and/or erosion resistance to the substrate.

It should be apparent to those skilled in the art that this invention may be embodied in many other specific forms without departing from the spirit of scope of the invention.

### EXAMPLE 1

The feasibility of manufacturing composite coatings for improved plasma erosion and chemical corrosion behavior was documented through optical and scanning electron microscopy (SEM) micrographs of composite coating cross-sections. The composite coatings were produced using the plasma spray technique in which multiple powder dispensers were utilized to supply feedstock to a single Praxair Surface Technologies, Inc. (PST) plasma spray torch that was controlled by a PST gas panel. Volume percentages of each phase were regulated by controlling the feed rates of each powder dispenser.

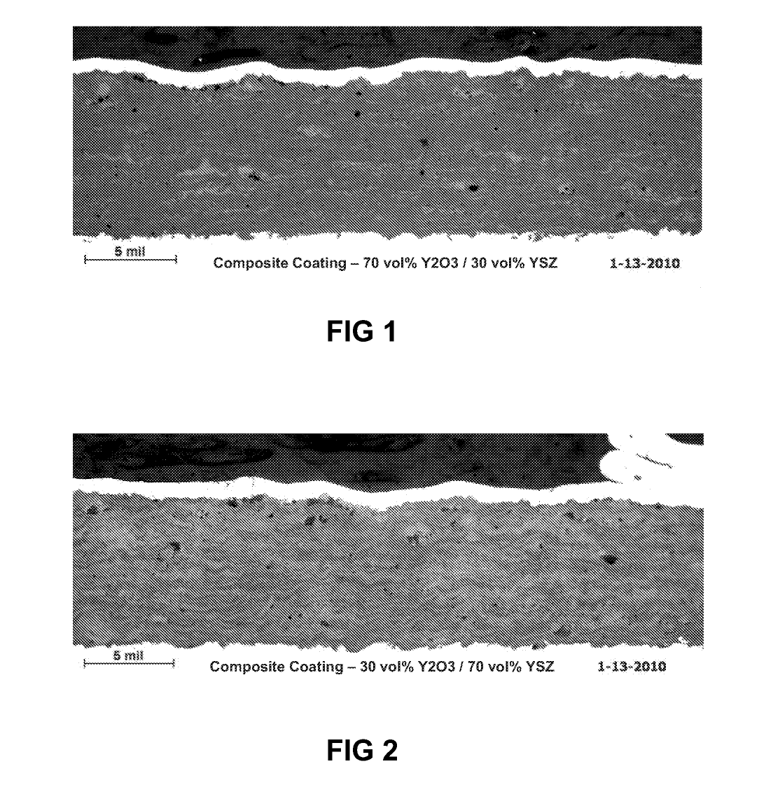

Optical micrographs of polished cross-sections from four different composite coatings comprised of Y₂O₃ and 17 weight % yttria stabilized zirconia (YSZ) are presented in FIGS. 1-4. FIGS. 1, 2 and 3 illustrate various volume percentages of the two phases, which are randomly and uniformly dispersed throughout the volume of coating. The ratios presented include 30 volume % Y₂O₃ and 70 volume % YSZ, 50 volume % Y₂O₃ and 50 volume % YSZ, and 70 volume % Y₂O₃ and 30 volume % YSZ. In addition, a composite coating comprised of distinct layers, including a topcoat and undercoat layer, is illustrated in FIG. 4. The topcoat layer is comprised of 100 volume % Y₂O₃, while the undercoat layer is comprised two sublayers, a 50 volume % Y₂O₃ and 50 volume % YSZ layer at the interface that transitions into a 70 volume % Y₂O₃ and 30 volume % YSZ layer.

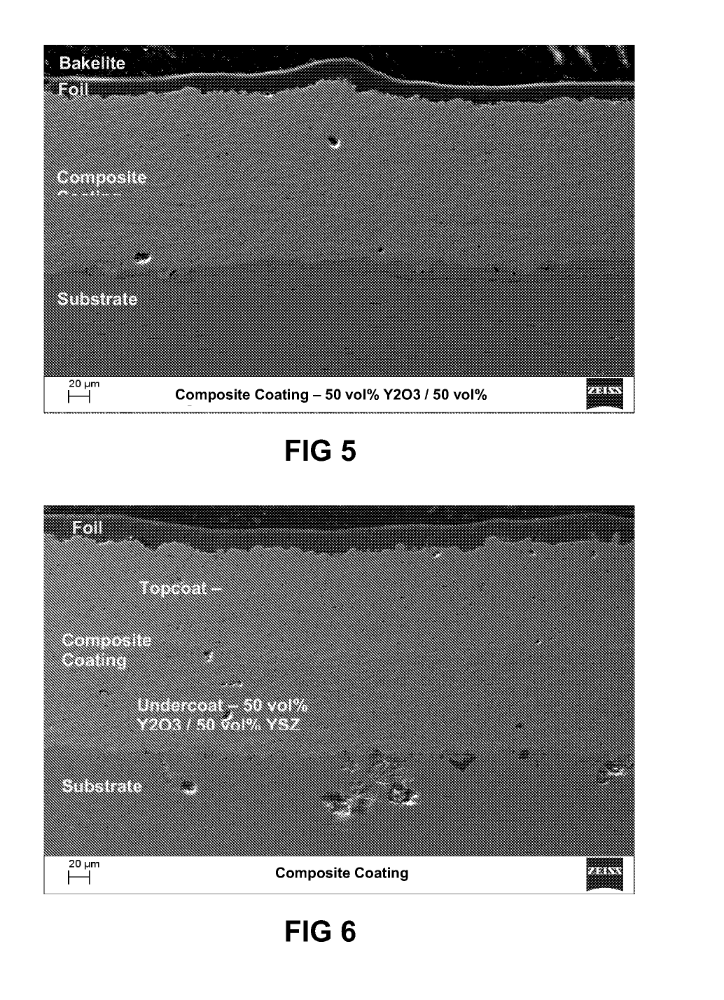

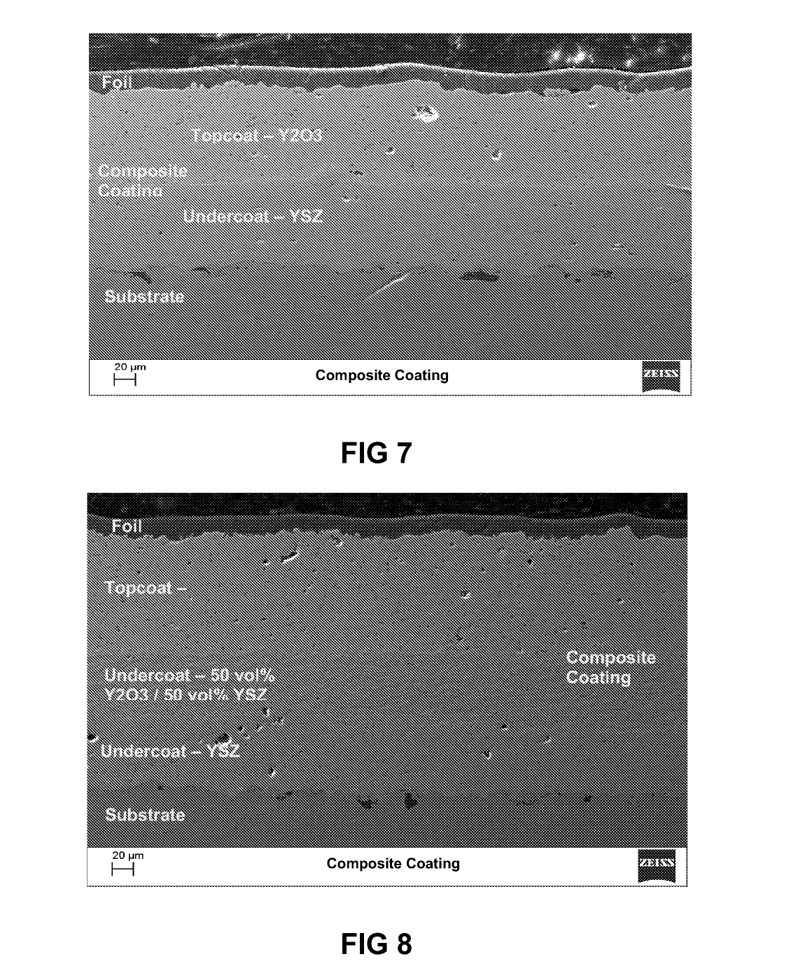

Scanning electron microscope (SEM) micrographs of polished cross-sections from four different composite coatings comprised of Y₂O₃ and 17 weight % yttria stabilized zirconia (YSZ) are illustrated in FIGS. 5-8. FIG. 5 illustrates a composite coating with a single volume percent ratio of two phases, 50 volume % Y₂O₃ and 50 volume % YSZ, which is randomly and uniformly distributed throughout the volume of coating. FIGS. 6 and 7 illustrate composite coatings with topcoats and undercoats of various configurations. For the examples illustrated, the topcoat is consistently 100 volume % Y₂O₃, while the undercoat consists of various combinations of single or multiple sublayers. The topcoat was chosen to be 100% yttria to maximize plasma erosion resistance, while the undercoat layers were chosen to include volume percentages of YSZ to maximize corrosion resistance at the interface. For example, FIG. 8 illustrates a composite coating with an undercoat layer comprised of 100 volume % YSZ at the substrate interface topped with a 50 volume % Y₂O₃ and 50 volume % YSZ randomly distributed sublayer, and a topcoat layer of 100% Y₂O₃.

### EXAMPLE 2

Plasma erosion resistance of a 50 volume % Y₂O₃ and 50 volume % 17 weight % YSZ uniformly distributed composite coating was characterized in comparison to 100 volume % Y₂O₃ coatings and 100 volume % 17 weight % YSZ coatings. A reactive ion etch (RIE) method was utilized plasma erode the coatings. The RIE was performed for a total of 60 hours and employed two different gas etch chemistries, SF₆:O₂ and CF₄:O₂. The measurement technique utilized to quantify the plasma erosion rates provided a precision level of ±0.5 μm. A Zeiss Confocal microscope (CSM 700) was used to measure the step height across a masked interface post plasma erosion. Coating surfaces were polished to very smooth finishes (i.e., Ra˜0.2 μm) in order to ensure the step height due to plasma erosion could clearly be differentiated. Two samples per coating type were tested with each sample having 20 individual plasma erosion rate measurements taken for a total of 40 total measurements per coating condition.

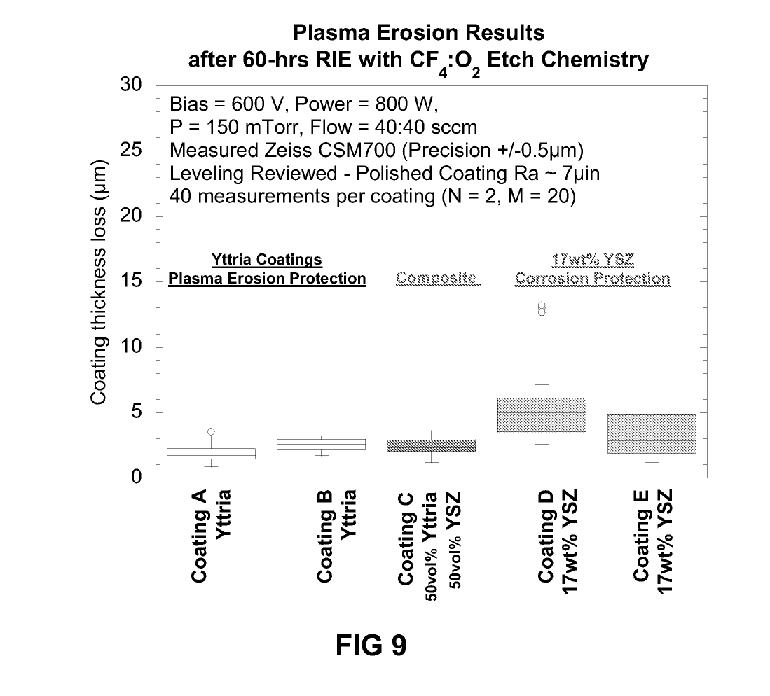

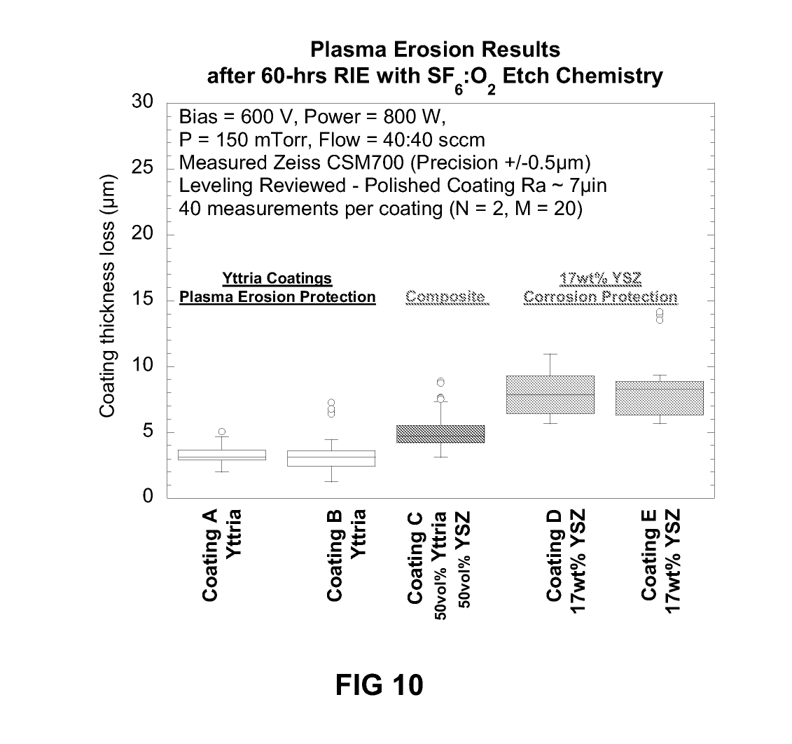

FIG. 9 graphically illustrates the plasma erosion by loss in coating thickness per 60 hour exposure in RIE with a CF₄:O₂ gas chemistry. In the CF₄:O₂ chemistry, the composite coating performs better than 100 volume % 17 weight % YSZ, and equivalently to the 100 volume % Y₂O₃ (Coating B). Coating A, comprised of 100 volume % Y₂O₃, provided the best plasma erosion resistance of all the coatings tested. FIG. 10 graphically illustrates the plasma erosion by loss in coating thickness per 60 hour exposure in RIE with a SF₆:O₂ gas chemistry. The SF₆:O₂ more aggressively eroded the coatings in comparison to the CF₄:O₂ chemistry. For example, Coating A eroded 1.7±0. μm in the CF₄:O₂ chemistry, and 3.2±0.7 μm in the SF₆:O₂ chemistry. Similar to the CF₄:O₂ chemistry, the composite coating provided increased plasma erosion resistance compared to the 100 volume % YSZ, but less plasma resistance than 100 volume % yttria. In general, the 50 volume % Y₂O₃ and 50 volume % 17 weight % YSZ uniformly distributed composite coating followed the rule of mixtures with respect to plasma erosion performance. In addition, the composite coating demonstrated distinct plasma erosion behavior from that of either single phase coating.

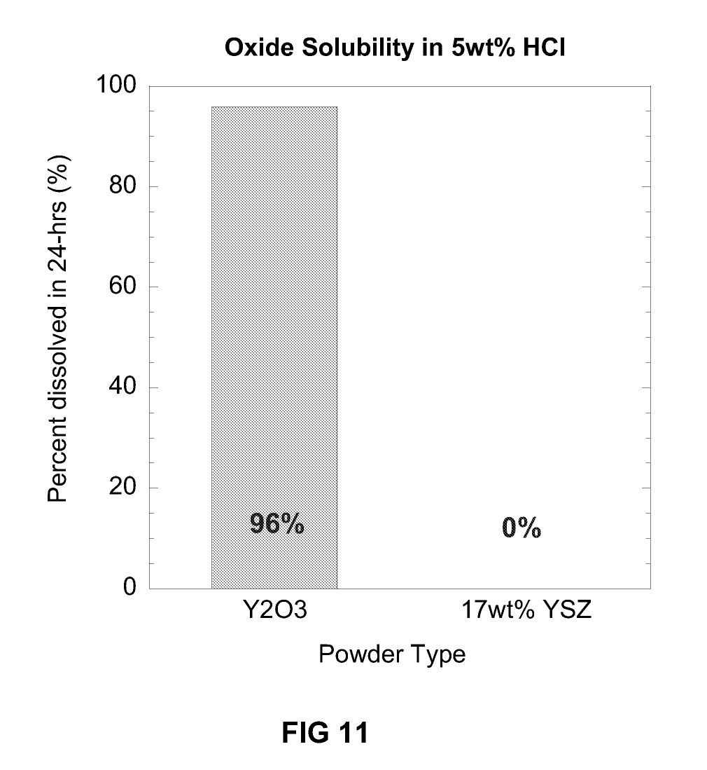

While, the plasma erosion resistance of the composite coating was slightly less than that of 100 volume % yttria, the composite coating provides improvements in corrosion protection. The 17 weight % YSZ was chosen based on the insolubility of YSZ in mineral acids. For example, FIG. 11 graphically depicts the percentage of Y₂O₃ and 17 weight % YSZ powder dissolved in a 5 weight % HCl solution after 24 hours. In 24 hours, 96% of the yttria dissolved, while none of the 17 weight % YSZ had dissolved. Coatings comprised of 17 weight % YSZ, specifically composite coatings incorporating 17 weight % YSZ, provide increased chemical corrosion resistance due to their insolubility in HCl and other mineral acids.

### EXAMPLE 3

Ceramic composite coatings were manufactured consistent with those described in Example 1. The ceramic composite coatings demonstrate improvements in coating performance, specifically, maintaining high levels of coating bond strength due to increased corrosion resistance. In addition, certain ceramic composite coatings demonstrate these improvements in corrosion resistance, while still maintaining the highest levels of plasma erosion at the free surface.

Semiconductor chamber components in dry etch tools are often limited in lifetime by the number of wet chemical cleaning cycles parts experience before coating degradation and/or delamination occurs. In service, semiconductor chamber components build up etch by-products primarily consisting of polymer deposits at the part's surface, which must be periodically removed to maintain high quality semiconductor chips at an acceptable yield rate. Cleaning the chamber components generally involves mechanical scrubbing, harsh acids, hot water soaks, and drying in ovens at low temperatures. Increasing the coatings corrosion resistance is a desired initiative for thermally sprayed coatings utilized in chamber components.

Corrosion resistance of ceramic composite coatings was evaluated by cyclic application of an overly aggressive cleaning cycle. The process for a single test cleaning cycle consisted of an acid wipe, hot deionized (DI) water soak, and dry atmospheric bake in an oven. The process was repeated for 15 total cycles. Hydrofluoric acid (HF) was utilized in the following tests for two reasons: 1) previous internal work determined HF to be more detrimental to coating adhesion than other common cleaning acids, e.g. hydrochloric or nitric acid, and 2) common etch chemistries, e.g., SF₆ and CF₄, are known to react with water vapor to form hydrofluoric acid prior to cleaning The strength of the HF was set at 10 weight percent. The coatings were applied to roughened aluminum bond caps, and bond strength tested consistent with ASTM C633. The bond strength of the half of a coating group was tested in the as-coated condition, no exposure to HF, while the other half experienced cyclic corrosion testing prior to bond strength testing.

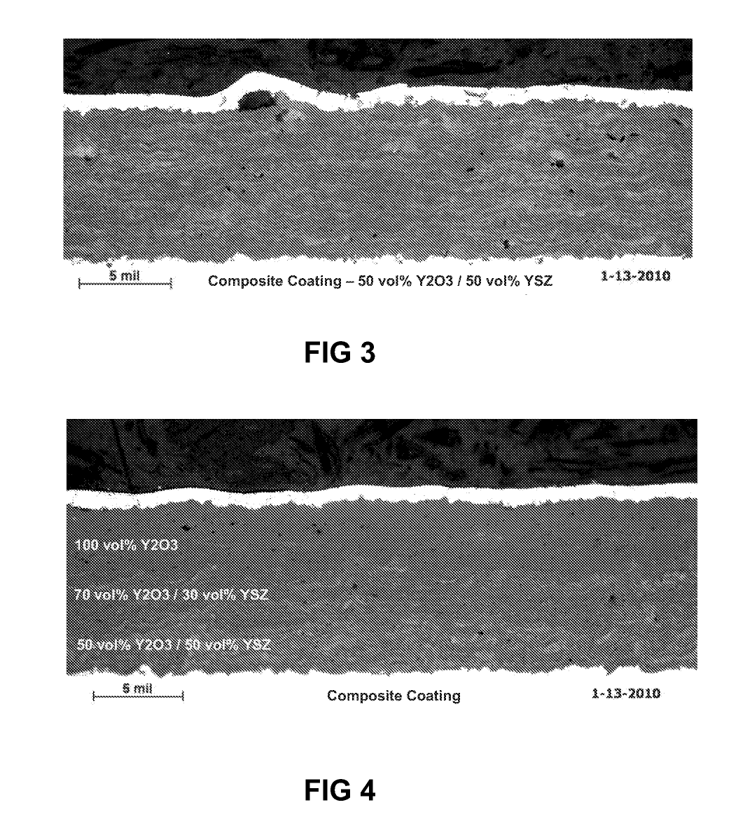

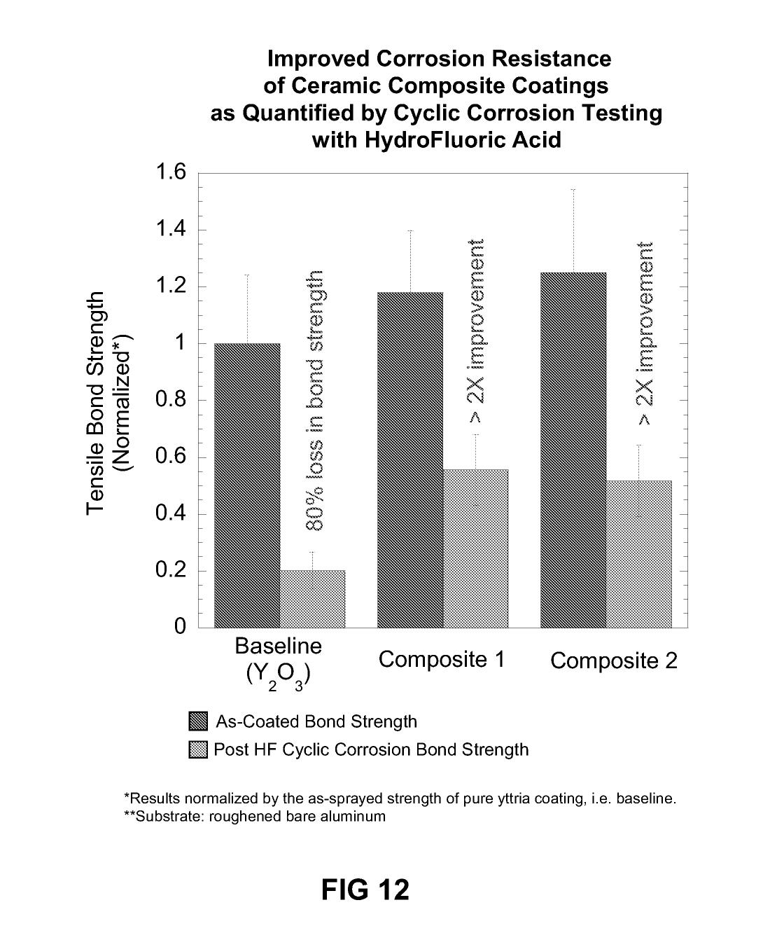

FIG. 12 shows the bond strength results for a baseline yttria coating, and two composite coatings subjected to cyclic corrosion testing with HF. Composite 1 in FIG. 12 is a 50 volume % yttria/50 volume % YSZ composite, which is previously presented in Example 1 (FIGS. 3 and 5). Composite 2 of FIG. 12 is a layered composite with a 100% yttria topcoat, and a 50 volume % yttria/50 volume % YSZ undercoat previously presented in Example 1 (FIG. 6). The composite coatings demonstrate greater than a 2× improvement in retained bond strength compared to the baseline yttria coating. This improvement in bond strength correlates to longer lifetimes of semiconductor chamber parts due to an increased ability to survive wet chemical cleaning cycles in the field. Further, Composite 2 of FIG. 12 demonstrates greater than 2× improvement in corrosion protection due to the sublayer undercoat, while maintaining maximum plasma erosion resistance with the 100 volume percent yttria topcoat.

1. A thermal spray composite coating on a metal or non-metal substrate, said thermal spray coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.

2. The thermal spray composite coating of claim 1 wherein said at least first ceramic material phase has a size and shape sufficient to provide corrosion resistance to said ceramic composite coating, and said at least second ceramic material phase has a size and shape sufficient to provide plasma erosion resistance to said ceramic composite coating.

3. The thermal spray composite coating of claim 1 wherein said at least first ceramic material phase is, relative to said at least second ceramic material phase, randomly and uniformly dispersed throughout said ceramic composite coating and/or spatially oriented throughout said ceramic composite coating sufficient to provide corrosion resistance to said ceramic composite coating, and said at least second ceramic material phase is, relative to said at least first ceramic material phase, randomly and uniformly dispersed throughout said ceramic composite coating and/or spatially oriented throughout said ceramic composite coating sufficient to provide plasma erosion resistance to said ceramic composite coating.

4. The thermal spray composite coating of claim 1 which is prepared by a process comprising (i) feeding at least two ceramic coating materials to at least one thermal spray device, (ii) operating said at least one thermal spray device to deposit the at least two ceramic coating materials on a metal or non-metal substrate to produce the ceramic composite coating, and (iii) varying at least one operating parameter of the at least one thermal spray device during deposition of said at least two ceramic coating materials sufficient to randomly and uniformly disperse and/or spatially orient said at least two ceramic material phases throughout the ceramic composite coating.

5. The thermal spray composite coating of claim 4 wherein the operating parameters of the at least one thermal spray device that can be varied comprise temperature of the depositing the at least two ceramic coating materials, velocity of the depositing at least two ceramic coating materials as they contact the metal or non-metal substrate, and standoff of the at least one thermal spray device.

6. The thermal spray composite coating of claim 4 wherein said at least two ceramic coating materials are heated to about their melting point to form droplets of the at least two ceramic coating materials, and the droplets are accelerated in a gas flow stream to contact said metal or non-metal substrate.

7. The thermal spray composite coating of claim 6 wherein the temperature parameters of the at least two ceramic coating materials comprise temperature and enthalpy of the gas flow stream; composition and thermal properties of the droplets; size and shape distributions of the droplets; mass flow rate of the droplets relative to the gas flow rate; and time of transit of the droplets to the metal or non-metal substrate.

8. The thermal spray composite coating of claim 6 wherein the velocity parameters of the at least two ceramic coating materials comprise gas flow rate; size and shape distribution of the droplets; and mass injection rate and density of the droplets.

9. The thermal spray composite coating of claim 4 wherein the at least one thermal spray device is selected from a plasma spray device, a high velocity oxygen fuel device, a detonation gun, and an electric wire arc spray device.

10. The thermal spray composite coating of claim 1 wherein said at least two ceramic material phases have interfaces therebetween.

11. The thermal spray composite coating of claim 1 wherein the first ceramic material phase comprises zirconium oxide, yttrium oxide, magnesium oxide, cerium oxide, aluminum oxide, hafnium oxide, oxides of Groups 2A to 8B inclusive of the Periodic Table and the Lanthanide elements, or alloys or mixtures or composites thereof, and wherein the second ceramic material phase comprises yttrium oxide, zirconium oxide, magnesium oxide, cerium oxide, aluminum oxide, hafnium oxide, oxides of Groups 2A to 8B inclusive of the Periodic Table and the Lanthanide elements, or alloys or mixtures or composites thereof.

12. The thermal spray composite coating of claim 1 wherein the first ceramic material phase comprises a zirconia-based coating selected from zirconia, partially stabilized zirconia and fully stabilized zirconia, and wherein the second ceramic material phase comprises yttrium oxide, zirconium oxide, aluminum oxide, cerium oxide, hafnium oxide, gadolinium oxide, ytterbium oxide, or alloys or mixtures or composites thereof.

13. The thermal spray composite coating of claim 1 which comprises one or more layers.

14. A process for producing a thermal spray composite coating on a metal or non-metal substrate, said thermal spray composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating; said process comprising (i) feeding at least two ceramic coating materials to at least one thermal spray device, (ii) operating said at least one thermal spray device to deposit the at least two ceramic coating materials on said metal or non-metal substrate to produce the ceramic composite coating, and (iii) varying at least one operating parameter of the at least one thermal spray device during deposition of said at least two ceramic coating materials sufficient to randomly and uniformly disperse and/or spatially orient said at least two ceramic material phases throughout the ceramic composite coating.

15. The process of claim 14 wherein the operating parameters of the at least one thermal spray device that can be varied comprise temperature of the depositing the at least two ceramic coating materials, velocity of the depositing at least two ceramic coating materials as they contact the metal or non-metal substrate, and standoff of the at least one thermal spray device.

16. The process of claim 14 wherein said at least two ceramic coating materials are heated to about their melting point to form droplets of the at least two ceramic coating materials, and the droplets are accelerated in a gas flow stream to contact said metal or non-metal substrate.

17. The process of claim 16 wherein the temperature parameters of the at least two ceramic coating materials comprise temperature and enthalpy of the gas flow stream; composition and thermal properties of the droplets; size and shape distributions of the droplets; mass flow rate of the droplets relative to the gas flow rate; and time of transit of the droplets to the metal or non-metal substrate.

18. The process of claim 16 wherein the velocity parameters of the at least two ceramic coating materials comprise gas flow rate; size and shape distribution of the droplets; and mass injection rate and density of the droplets.

19. The process of claim 14 wherein the at least one thermal spray device is selected from a plasma spray device, a high velocity oxygen fuel device, a detonation gun, and an electric wire arc spray device.

20. An article comprising a metal or non-metal substrate and a thermal spray composite coating on the surface thereof; said thermal spray composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.

21. The article of claim 20 which is prepared by a process comprising (i) feeding at least two ceramic coating materials to at least one thermal spray device, (ii) operating said at least one thermal spray device to deposit the at least two ceramic coating materials on a metal or non-metal substrate to produce the ceramic composite coating, and (iii) varying at least one operating parameter of the at least one thermal spray device during deposition of said at least two ceramic coating materials sufficient to randomly and uniformly disperse and/or spatially orient said at least two ceramic material phases throughout the ceramic composite coating.

22. The article of claim 20 wherein said metal or non-metal substrate comprises an internal member of a plasma treating vessel.

23. The article of claim 22 wherein said internal member is selected from a deposit shield, baffle plate, focus ring, insulator ring, shield ring, bellows cover, electrode, chamber liner, cathode liner, gas distribution plate, and electrostatic chuck.

24. The article of claim 20 wherein the plasma treating vessel is used in the production of an integrated circuit component.

25. A method for protecting a metal or non-metal substrate, said method comprising applying a thermally sprayed composite coating to said metal or non-metal substrate, said thermally sprayed composite coating comprising a ceramic composite coating having at least two ceramic material phases randomly and uniformly dispersed throughout said ceramic composite coating and/or spatially oriented throughout said ceramic composite coating, wherein at least a first ceramic material phase is present in an amount sufficient to provide corrosion resistance to said ceramic composite coating, and at least a second ceramic material phase is present in an amount sufficient to provide plasma erosion resistance to said ceramic composite coating.
